(19) United States
(12) Patent Application Publication
(10) Pub. No.: US 2011/0247324 A1
(43) Pub. Date: Oct. 13, 2011

(54) VACUUM-ASSISTED BRAKE-FORCE BOOSTER AND METHOD FOR ADJUSTMENT THEREOF

(76) Inventors: Peter Schlüter, Kammerforst (DE); Frank Schlüter, Boppard (DE); Alexander Schlüter, Kammerforst (DE); Stefan Schlüter, Kammerforst (DE); Irina Gerdt, Kammerforst (DE)

(21) Appl. No.: 12/739,528

(22) PCT Filed: Oct. 9, 2008
(86) PCT No.: PCT/EP08/08534

§ 371 Date: Jan. 11, 2011

(30) Foreign Application Priority Data
Oct. 25, 2007 (JP) 10 2007 051 199.1

(51) Int. Cl. B60T 13/57; B23P 11/00

(52) U.S. Cl. 60/547.1; 29/428

(57) ABSTRACT

A brake-force booster for a motor-vehicle braking system has a booster housing, with a force-input member which is capable of being coupled to a brake pedal and which can be inserted into the booster housing against the action of a return spring, with a force-output member which is capable of being coupled to a brake cylinder, with a chamber arrangement with a working chamber and a vacuum chamber, which are separated by a movable wall, with a control-valve arrangement arranged between the force-input member and the force-output member, wherein the control-valve arrangement exhibits a first valve seat for optional connecting of the working chamber to external atmosphere, and a second valve seat for optional connecting of the working chamber to the vacuum chamber. A setting of the response force of the brake-force booster is effected by means of a stop sleeve on which the return spring is supported, whereby for the purpose of setting a bias of the return spring the stop sleeve is capable of being displaced relative to the force-input member and is capable of being fixed to the latter in a setting position.

### CROSS-REFERENCE TO RELATED APPLICATIONS

This application is a national stage of International Application No. PCT/EP2008/008534 filed Oct. 9, 2008, the disclosure of which is incorporated herein by reference, and which claimed priority to German Patent Application No. 10 2007 051 199.1 filed Oct. 25, 2007, the disclosure of which is incorporated herein by reference.

### BACKGROUND OF THE INVENTION

The present invention relates to a brake-force booster for a motor-vehicle braking system with a booster housing, with a force-input member which is capable of being coupled to a brake pedal and which can be inserted into the booster housing against the action of a return spring, with a force-output member which is capable of being coupled to a brake cylinder, with a chamber arrangement with a working chamber and a vacuum chamber, which are separated by a movable wall, and with a control-valve arrangement arranged between the force-input member and the force-output member, wherein the control-valve arrangement exhibits a first valve seat for optional connecting of the working chamber to an external atmosphere, and a second valve seat for optional connecting of the working chamber to the vacuum chamber.

A brake-force booster of such a type is known from the state of the art. For instance, document DE 42 27 879 A1, and corresponding U.S. Pat. No. 5,546,846, both of which are incorporated by reference herein, presents a brake-force booster of the type indicated in the introduction. With this brake-force booster a compression spring is provided which is supported on the force-input member with its one end on a support of the valve member and with its other end on a shoulder. This compression spring acts as a return spring for the force-input member and has to guarantee that the brake-force booster returns automatically to its initial position when the force-input member is released. In the process, forces have to be overcome that result from differences in pressure applied to the control valve, for which reason the return spring has to act with a certain minimum force. On the other hand, the return spring must not be designed to be too strong, because otherwise the actuating forces on the force-input member are too high and would not be accepted by a driver.

It has, however, become evident in this connection that with such an arrangement of the return spring unfavourable situations may occur by reason of manufacturing tolerances in the design of the return spring and also of the arrangement of the shoulder on the force-input member. Thus it is possible that in the case of a combination of a return spring that still lies within the admissible tolerance band and that is rather more rigid and a shoulder still lying within the tolerance band close to the spherical end undesirably high actuating forces may occur which are no longer accepted by the driver or by the motor-vehicle manufacturer. In the converse case of a combination of a return spring still lying within the admissible tolerance band and that is rather weaker and a shoulder still lying within the tolerance band, further away from the spherical end, a sufficient restoring action still has to be guaranteed, for which reason in a tolerance situation differing from this extreme tolerance situation the return spring always generates a greater restoring force than is precisely necessary for its function. Although document DE 42 27 879 A1 proposes creating a pneumatic equalisation of pressure at the valve member for the purpose of reducing the actuating forces, the problem, described above, of unfavourable combinations of return spring and shoulder still lying within the tolerance band or tolerance range is not confronted by this measure.

### BRIEF SUMMARY OF THE INVENTION

A feature of the present invention is to make available a brake-force booster for a motor-vehicle braking system, with which the response force can be set cost-effectively and with simple structural means and hence can be reduced on demand.

This feature is achieved by a brake-force booster of the type indicated in the introduction, in which there is provided a stop sleeve on which the return spring is supported, the stop sleeve being displaceable for the purpose of setting a bias of the return spring relative to the force-input member, and being capable of being fixed to the latter in a setting position.

In accordance with the invention, there is accordingly provision that by virtue of the arrangement of a stop sleeve the bias of the return spring by setting the setting position of the stop sleeve where necessary a reduction of the response force of the brake-force booster becomes possible. By the term ‘response force’ in this connection a force is to be understood that acts against the actuation of the brake-force booster by the driver and that has to be overcome in order to trigger the boosting function of the brake-force booster. A substantial part of the response force is generated by the return spring, which, depending on the desired behaviour of the booster, is placed more or less strongly under bias. Said return spring should in any case be so strongly biased that it guarantees a reliable return of the brake-force booster to its initial position. On the other hand, it should not be to strong, in order to keep the actuating forces within a range that is acceptable for the driver and the motor-vehicle manufacturer.

By virtue of an axial relocation of the stop sleeve accompanied by a reduction of or increase in the spring force of the return spring, the response force or actuating force of the brake-force booster can be set within certain bounds. Thus the axial position of the stop sleeve on the force-input member of the brake-force booster can be varied as a function of an actually established spring force of the return spring with regard to a specified force, whereby the respective tolerance situation of the return spring being used can be taken into account. By virtue of the invention, in comparison with the state of the art the response force of the brake-force booster can accordingly be set with relatively simple means and, where necessary, reduced, without interventions in the structural design of the control-valve arrangement itself having to be made on a massive scale.

In order to obtain a predefined response force of the brake-force booster, in a further development of the invention there is provision that the setting position of the stop sleeve is capable of being fixed in accordance with a predetermined bias of the spring.

With regard to the structural configuration of the force-input member of the brake-force booster according to the invention, a further development of the invention provides that the force-input member exhibits a groove which is covered by the stop sleeve, in particular by the shank thereof, in its longitudinal extent. In this connection, in accordance with the invention there may furthermore be provision that the force-input member exhibits an abutment flange which defines the end position of the stop sleeve on the force-input member. By the term ‘end position’ here, a position is to be understood in which the stop sleeve bears against the abutment flange with its end opposite the return spring and is no longer capable of being displaced further in the direction of the right-hand end of the force-input member. It consequently limits the possibility for axial adjustment of the stop sleeve in a direction in which the tension of the return spring is relaxed.

An embodiment variant of the invention provides that the material of the stop sleeve is deformable in such a manner that it at least partly engages with the groove of the force-input member and, as a result, can be fixed in its axial position.

With regard to the shape of the stop sleeve of the brake-force booster according to the invention, a further development provides that the stop sleeve exhibits at its end facing towards the return spring a collar with a diameter that is enlarged in comparison with the shank. Besides this collar, the stop sleeve exhibits the shank with substantially constant diameter, with which the stop sleeve is relocatably supported on the force-input member in almost backlash-free manner. In accordance with the invention, the shank of the stop sleeve covers the groove of the force-input member, in order to be able to fix the stop sleeve in its axial position by deformation into the groove.

The invention further relates to a motor-vehicle braking system with a brake-force booster of the type described above.

In order to be able to adjust the brake-force booster described above, the present invention also relates to an adjusting mechanism with a housing which exhibits a cylindrical recess having a bottom and a receiving region, with a force-transmitting device received in the receiving region and with a relocatable adjusting sleeve which is situated upstream of the receiving region.

In order to be able to fix the stop sleeve in a desired position by means of the adjusting mechanism, a further development of the invention provides that the force-transmitting device in the receiving region exhibits a tappet arrangement for deforming the stop sleeve. In this connection, in accordance with the invention there may furthermore be provision that the tappet arrangement exhibits a first and a second tappet, whereby a deformation force exerted on the first tappet is capable of being transmitted to the stop sleeve via the second tappet and whereby the second tappet exhibits a front face designed for deforming the stop sleeve, which grips the latter as a consequence of the deformation force exerted for the purpose of deformation of the stop sleeve.

With regard to the structural configuration of the adjusting mechanism, there may furthermore be provision that the recess in the housing of the adjusting mechanism is formed so as to correspond to the shape of the force-input member of the brake-force booster.

The invention further relates to a method for adjusting a brake-force booster with an adjusting mechanism described above, the method including the following steps:

mounting the adjusting mechanism onto the force-input member of the brake-force booster,

ascertaining the currently applied spring force of the return spring by means of the adjusting sleeve,

comparing the ascertained spring force and a predetermined response force of the brake-force booster,

relocating the stop sleeve by means of the adjusting sleeve against the spring force of the return spring for the purpose of minimising an absolute difference between the actual spring force and the predetermined response force, and

fixing the stop sleeve by means of the adjusting mechanism when substantially the predetermined response force of the brake-force booster is attained, whereby the stop sleeve is deformed by the adjusting mechanism for the purpose of fixing to the force-input member.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is an axis-including schematic partial sectional view through the brake-force booster according to the invention and

FIG. 2 is a view, corresponding to FIG. 1, of the brake-force booster according to the invention with adjusting mechanism mounted.

### DETAILED DESCRIPTION OF THE INVENTION

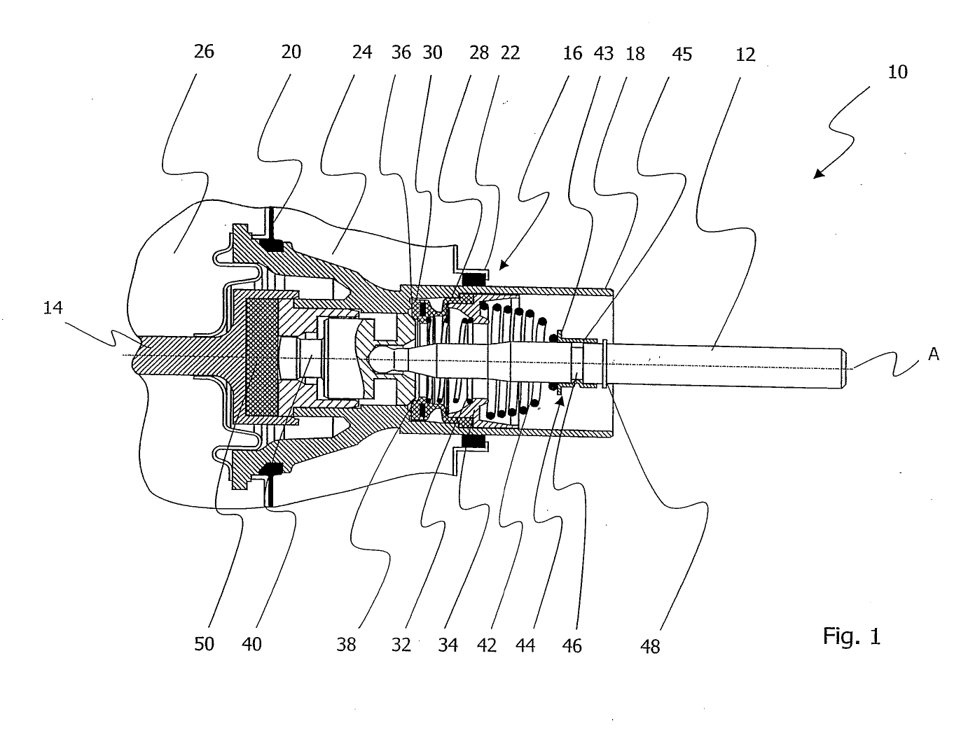

In FIG. 1 a brake-force booster according to the invention is denoted generally by 10. This brake-force booster 10 includes a force-input member 12 which is capable of being coupled with a brake pedal, not shown, and which extends along a longitudinal axis A. Furthermore, the brake-force booster 10 includes a force-output member 14 which is capable of being coupled with a brake cylinder, not shown, and likewise runs along the longitudinal axis A.

Between the force-input member 12 and the force-output member 14 there is arranged a control-valve arrangement 16. The control-valve arrangement 16 includes a control-valve casing 18 which is tightly connected to a movable wall 20. The movable wall 20 is received within a booster housing 22 and part of a chamber arrangement with a working chamber 24 and a vacuum chamber 26, which are separated by a movable wall 20. The vacuum chamber 26 is capable of being connected to a vacuum source, not shown, of a motor vehicle. The working chamber 24 is optionally capable of being connected to the vacuum chamber 26 or to the ambient atmosphere.

In the control-valve casing 18 a sealing element 28 is provided. The sealing element 28 is endowed with an annular sealing face 30 which is biased to the left in FIG. 1 via a spring 32. The spring 32 is arranged between the sealing element 28 and a retaining element 34.

With the sealing face 30 there interacts an external valve seat 36 which is formed on the control-valve casing 18. If the sealing face 30 is lifted away from the external valve seat 36, the vacuum chamber 26 is connected to the working chamber 24. In the initial position according to FIG. 1 the vacuum chamber 26 is separated from the working chamber 24 by the sealing face 30.

Furthermore, with the sealing face 30 there interacts an internal valve seat 38 which is formed on an actuating piston 40 in the form of an inclined surface. If the internal valve seat 38 is lifted away from the sealing face 30, the working chamber 24 is connected to the atmosphere.

In the control-valve casing 18 a return spring 42 is furthermore arranged. The return spring 42 is biased against the retaining element 34 by a stop sleeve 44 with a shank 45 and with a collar 43 of larger outside diameter. The stop sleeve 44 is deformed into a groove 46 of the force-input member 12 in such a manner that it is fixed on the latter and in the process biases the return spring 42. Formed on the force-input member 12 furthermore is an abutment flange 48. This abutment flange 48 defines a possible end position of the stop sleeve 44 in relation to the return spring 42. The stop sleeve 44 is chosen in its longitudinal extent in such a way that it covers the groove 46 even in its end position in which it is applied against the abutment flange 48. With this manner of construction it is ensured that the stop sleeve 44 can be fixed to the force-input member 12 also in its end position by deformation into the groove 46. Depending on the axial position of the stop sleeve 44, a certain bias of the return spring 42 is obtained. In other words, the spring force of the return spring 42 can be varied and set as required as a function of the axial position of the stop sleeve 44 on the force-input member 12.

The brake-force booster 10 according to FIG. 1 functions in a manner known as such. With this brake-force booster the response force can be set to a predetermined specified value, which is reflected in the position of the stop sleeve 44, whereby this position may vary, depending on the actual spring force of the return spring 42. Upon an actuation of the brake pedal, which is not shown, the force-input member 12 is moved to the left in the axial direction. Together with this, the transmission piston 40 moves similarly to the left, whereby a brake-actuating force is exerted on the force-output member 14 via an elastic reaction element 50. By virtue of the movement of the transmission piston 40 to the left, the internal valve seat 38 is opened and consequently a connection between the working chamber 24 and the external atmosphere is made possible. By virtue of this connection, a difference in pressure arises on the movable wall 20. This causes the control-valve casing 18 to be moved to the left. As a result, in addition to the actuating force a servo force can be exerted on the force-output member 14.

Upon release of the brake pedal, by reason of the restoring forces of the master brake cylinder, the braking system and the return spring 42 the entire arrangement moves to the right into the initial position shown in FIG. 1. The internal valve seat 38, which separates the working chamber 24 from the external atmosphere, remains closed, but the external valve seat 36 between the working chamber 24 and the vacuum chamber 26 opens. As a result, an equalisation of pressure occurs, as a result of which the differential pressure on the movable wall 20 is reduced and the brake-force booster can move back into its initial position.

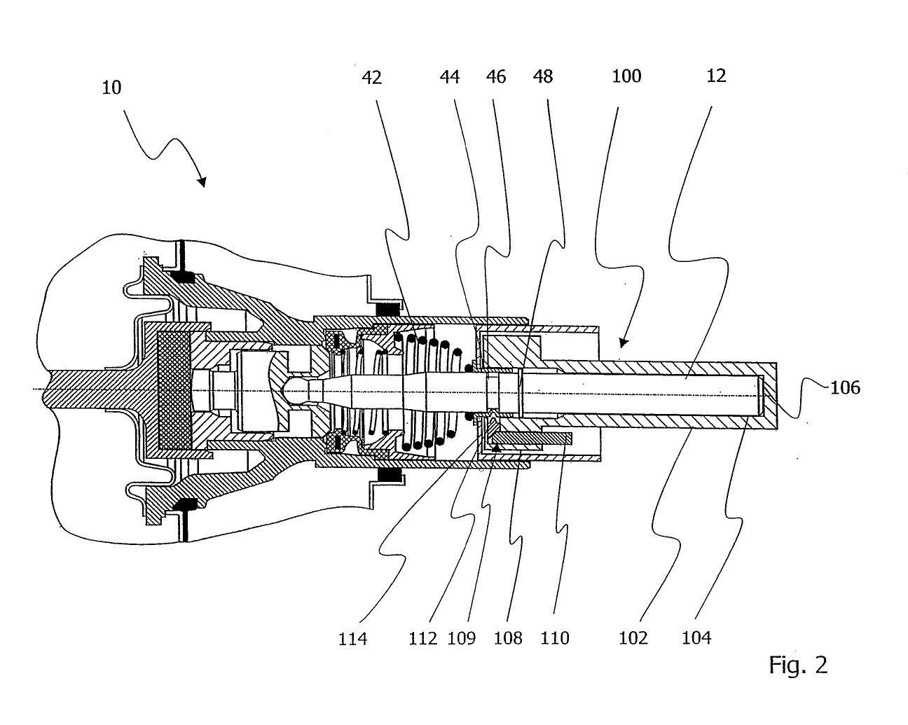

FIG. 2 shows the brake-force booster 10 according to the invention with adjusting mechanism 100 attached. A housing 102 of the adjusting mechanism 100 exhibits a cylindrical recess 104 with a bottom 106 and with a receiving region 108. In the receiving region 108 a tappet arrangement 109 with a first tappet 110 and a second tappet 112 is received. Furthermore, the adjusting mechanism 100 is endowed with an axially relocatable adjusting sleeve 114. The cylindrical recess 104 of the adjusting mechanism 100 is formed in such a manner that it corresponds to the shape of the force-input member 12 of the brake-force booster 10.

In the following the mode of operation of the adjusting mechanism 100 will be elucidated. The adjusting mechanism 100 with its recess 104 is attached onto the force-input member until the force-input member strikes the bottom 106 of the adjusting mechanism with its right-hand end. Subsequently the actual spring force of the return spring 42 in this state is ascertained by means of the adjusting sleeve 114. Thereupon the spring force, ascertained in this way, of the return spring 42 is compared with a specified value for this state which is being striven for. Directly after this, the adjusting sleeve 114 is relocated against the spring force of the return spring 42, in order to minimise the absolute difference between the actual spring force and the predetermined specified value of the response force of the brake-force booster 10. When the specified value which is being striven for is attained, the adjusting sleeve 114 is locked into position. A deformation force is then applied to the first tappet 110, for example by means of a moderate hammer blow or such like, said force being transmitted to the stop sleeve 44 by the second tappet 112. The front face of the second tappet is formed in such a manner that it is able to deform the stop sleeve 44 partly into the groove of the force-input member 12. By virtue of this deformation, the stop sleeve 44 is fixed in the desired position. At the same time, the return spring 42 remains biased with the predetermined specified value.

With the invention, the response force of the brake-force booster can be set as desired in relatively inexpensive manner and with simple structural means without a massive structural intervention into the structure of the brake-force booster becoming necessary. Tolerances of the return spring can be compensated, so that the actuating force can be kept to a specified level, even in mass production.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Brake-force booster for a motor-vehicle braking system with:
a booster housing,
a force-input member which is capable of being coupled to a brake pedal and which can be inserted into the booster housing against the action of a return spring,
a force-output member which is capable of being coupled to a brake cylinder,
a chamber arrangement with a working chamber and a vacuum chamber, which are separated by a movable wall, and
a control-valve arrangement arranged between the force-input member and the force-output member,
wherein the control-valve arrangement exhibits a first valve seat for optional connecting of the working chamber to the external atmosphere, and a second valve seat for optional connecting of the working chamber to the vacuum chamber,
characterised by a stop sleeve, on which the return spring is supported, whereby for the purpose of setting a bias of the return spring the stop sleeve is capable of being displaced relative to the force-input member and is capable of being fixed to the latter in a setting position.

2. Brake-force booster according to claim 1, wherein the setting position can be fixed in accordance with a predetermined bias of the return spring.

3. Brake-force booster according to claim 1, wherein the force-input member exhibits a groove, the stop sleeve covering the groove in its longitudinal extent.

4. Brake-force booster according to claim 3, wherein the stop sleeve is deformable in such a manner that it at least partly engages with the groove of the force-input member and is thereby fixed in its axial position.

5. Brake-force booster according to claim 1,
wherein the force-input member exhibits an abutment flange, the latter defining the end position of the stop sleeve.

6. Brake-force booster according to claim 1,
wherein the stop sleeve exhibits at its end facing towards the return spring a collar with enlarged outside diameter in comparison with a shank.

7. Motor-vehicle braking system with a brake-force booster according to claim 1.

8. Adjusting mechanism for adjusting a brake-force booster according to claim 1 with:
a housing which exhibits a cylindrical recess with a bottom and with a receiving region,
a force-transmitting device received in the receiving region, and
a relocatable adjusting sleeve which is situated upstream of the receiving region.

9. Adjusting mechanism according to claim 8, wherein the force-transmitting device in the receiving region exhibits a tappet arrangement for deforming the stop sleeve.

10. Adjusting mechanism according to claim 9, wherein the tappet arrangement exhibits a first and a second tappet, whereby a deformation force exerted on the first tappet is capable of being transmitted to the stop sleeve via the second tappet, whereby the second tappet exhibits a front face designed for deforming the stop sleeve.

11. Adjusting mechanism according to claim 8,
wherein the recess in the housing of the adjusting mechanism is formed so as to correspond to the shape of the force-input member.

12. Method for adjusting a brake-force booster according to claim 1, the method including the following steps:
providing an adjustment mechanism including a housing which exhibits a cylindrical recess with a bottom and with a receiving region, a force-transmitting device received in the receiving region, and a relocatable adjusting sleeve which is situated upstream of the receiving region,
mounting the adjusting mechanism onto the force-input member of the brake-force booster,
ascertaining the currently applied spring force of the return spring by means of the adjusting sleeve,
comparing the ascertained spring force and a predetermined response force of the brake-force booster,
relocating the stop sleeve by means of the adjusting sleeve against the spring force of the return spring for the purpose of minimising an absolute difference between the actual spring force and the predetermined response force, and
fixing the stop sleeve by means of the adjusting mechanism when substantially the predetermined response force of the brake-force booster is attained, whereby the stop sleeve is deformed by the adjusting mechanism for the purpose of fixing to the force-input member.
